(19) United States
(12) Patent Application Publication
(10) Pub. No.: US 2009/0144239 A1
(43) Pub. Date: Jun. 4, 2009

(54) METHODS INVOLVING MEASURING USER FEEDBACK IN INFORMATION RETRIEVAL

(75) Inventors: Korin J. Bevis, Farmington, MN (US); Kristine A. Henke, Racine, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,372

(22) Filed: Dec. 4, 2007

(51) Int. Cl. G06F 7/06

(52) U.S. Cl. 707/3; 707/102; 707/E17.014

(57) ABSTRACT

An exemplary method for measuring user feedback during information retrieval testing, the method comprising, determining whether a user has requested a page having a unique identifier in a data structure, requesting a first feedback input from the user responsive to determining that the user has requested the page, wherein the first feedback input is associated with a search for data in the data structure, receiving the first feedback input from the user, displaying the page, requesting a second feedback input from the user responsive to displaying the page, wherein the second feedback input is associated with a search for data in the data structure, associating the first and second feedback inputs with the page, and storing the first and second feedback inputs and a unique identifier of the page.

### BACKGROUND OF THE INVENTION

a. Field of the Invention

This invention relates generally to methods for measuring user feedback during information retrieval, and specifically to measuring and compiling user feedback during information retrieval testing.

b. Description of Background

The use of information retrieval systems such as pages on the Internet and databases has led to studies to determine the ease of use and intuitive nature of web pages for data retrieval. Since the designs of pages are virtually unlimited, it is desirable to determine what types of designs and organizational structures offer users an intuitive interface. Thus, studies to determine user confidence as a user navigates a data structure have been conducted. These studies may then be used to change an interface and associated data structures to make the search for data more intuitive and efficient, thereby increasing the confidence a user has while searching for information and increase the user's success in finding the information. Previously, the users have been asked to record their feedback comments as they search for data verbally or by using a form. Previous methods have been cumbersome and inefficient.

A method for efficiently recording and compiling user feedback data related to the impressions of a user while searching for data in a data structure during information retrieval testing is desired.

### SUMMARY OF THE INVENTION

The shortcomings of the prior art are overcome and additional advantages are achieved through an exemplary method for measuring user feedback during information retrieval testing, the method comprising, determining whether a user has requested a page having a unique identifier in a data structure, requesting a first feedback input from the user responsive to determining that the user has requested the page, wherein the first feedback input is associated with a search for data in the data structure, receiving the first feedback input from the user, displaying the page, requesting a second feedback input from the user responsive to displaying the page, wherein the second feedback input is associated with a search for data in the data structure, associating the first and second feedback inputs with the page, and storing the first and second feedback inputs and a unique identifier of the page.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a block diagram of all exemplary method for measuring user feedback during information retrieval testing.

FIG. 2 illustrates an exemplary system for measuring user feedback during information retrieval testing.

FIGS. 3-6 illustrate the method shown in FIG. 1.

The detailed description explains the preferred embodiments of the invention, together with advantages and features, by way of example with reference to the drawings.

### DETAILED DESCRIPTION OF THE INVENTION

Methods involving measuring user feedback during information retrieval testing are provided. Several exemplary embodiments are described.

Users use data structures that include for example, databases and the Internet to search for and retrieve data. Often the users use a graphical display such as a browser that displays pages containing information and links to other information stored in the data structure. The pages and the data structures may be organized in a variety of styles that include, for example, the location of links on a page and the availability of specific links on a page.

The prevalence of using pages to find data has led to studies of particular page and data structure designs to determine if a user can successfully and efficiently find desired data. One way to determine the usefulness of a page or other interlace for a data structure is to test users as they are searching for data. One way to test users is to give a user a particular search topic and ask the user to Find information data associated with the search topic. As the user works to find the data, a tester solicits feedback from the user. Feedback may include, for example, the user's confidence on a numerical scale that that they are moving, through the data structure and will find the data. Previous methods for soliciting feedback used verbal recordings or notes written by a user to record user feedback. It is desirable for a system to efficiently and effectively collect user feedback data and that may be easily compiled and displayed for analysis by the testers.

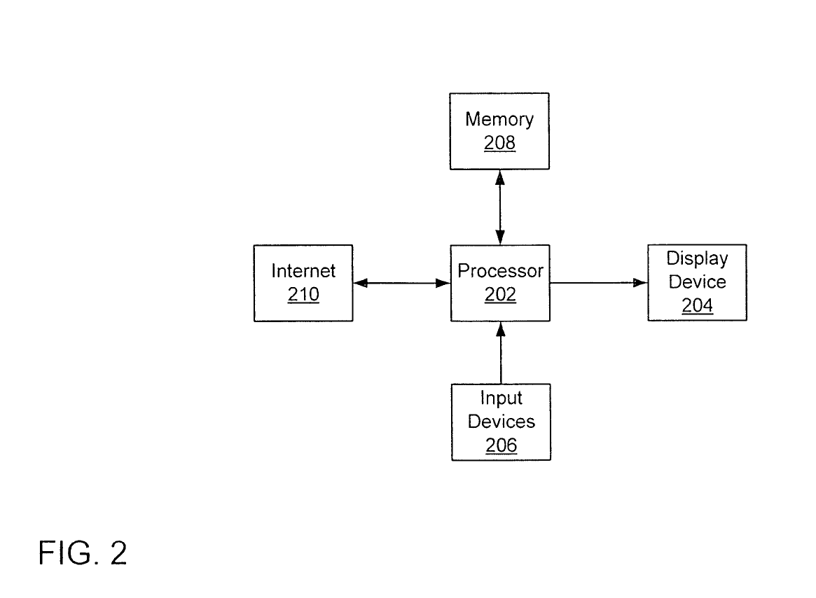

FIG. 2 illustrates an exemplary system used to perform the methods described below. The system includes a processor 202 communicatively linked to a memory 208, input devices 206, a display device 204, and the Internet 210. The memory 208 may include a database or other types of data structures.

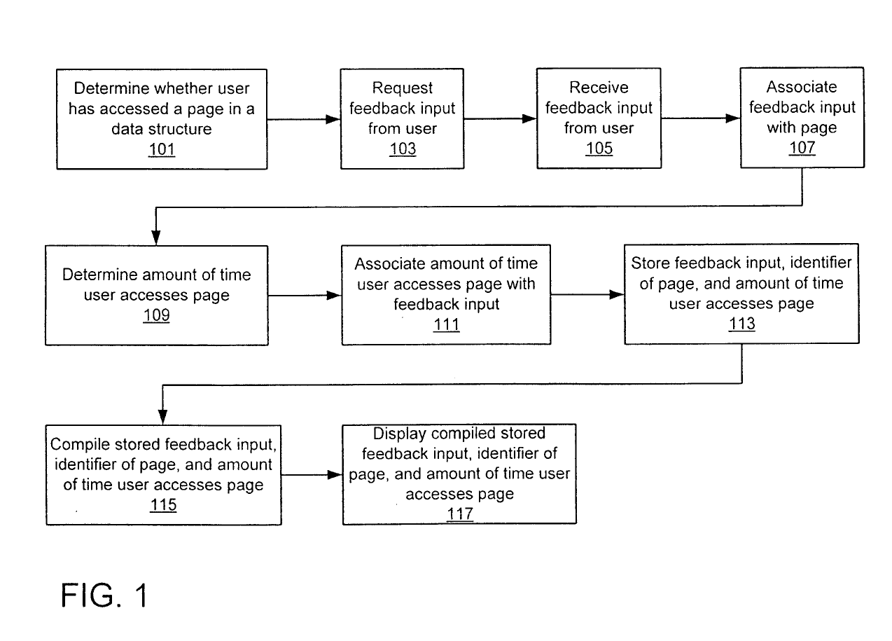

FIG. 1 illustrates a block diagram of a method for measuring user feedback during information retrieval testing. An exemplary test scenario may include, for example, giving a user a particular data topic stored in a data structure. The user is directed to find data related to the data topic. For example, a user may be given a topic such as “Great Danes.” A user is then instructed to use a data structure, such as an Internet website that includes pages about dogs. The exemplary method of FIG. 1 allows user feedback taken during a search for the topic to be saved and compiled. Feedback data may include, for example, a confidence level for the search (i.e., the user feels that as they navigate the pages of the website they are coming closer to the given topic), or a rating of the ease Of use of the page. The feedback data may be solicited after each page is displayed, periodically based on the time elapsed in the search, or after particular pages are displayed. A unique identifier for each page may also be associated with the feedback data to allow testers to evaluate particular pages. The time a user spends looking at a particular page may also be associated with the unique identifier to allow further analysis by the testers.

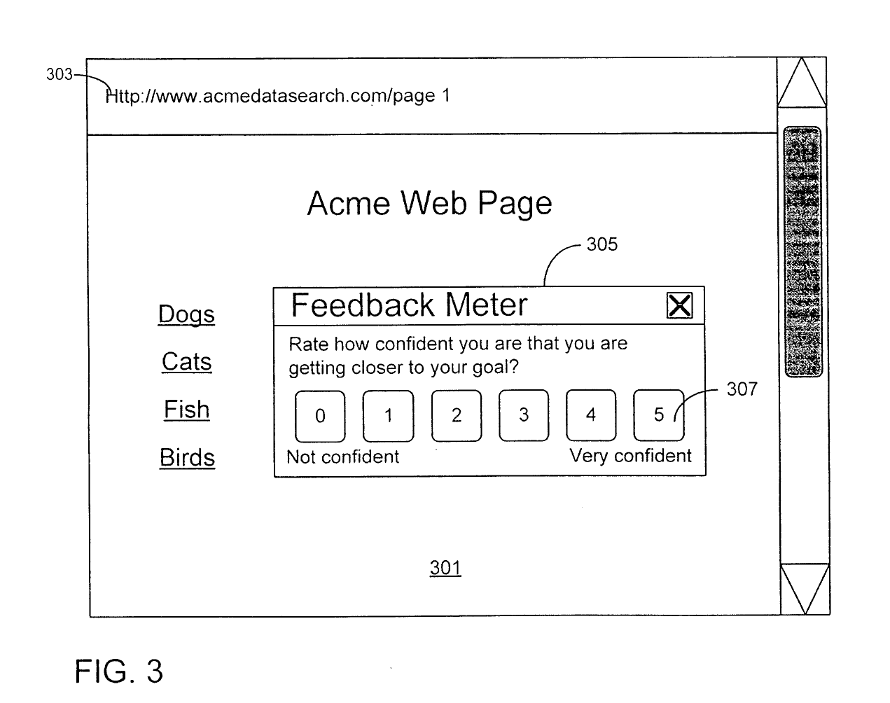

Referring to FIG. 1, in block 101 it is determined whether the user has requested a page designated for feedback data in a data structure. In block 102, the user is requested to make a first feedback input. The first feedback input may indicate the confidence a user has that the requested page will lead to the given data topic. Once the first feedback input is received in block 103, the requested page is displayed in block 104. After the requested page is displayed, the user is requested to input a second feedback input in block 105. The second feedback input, received after the requested page is displayed may again indicate the confidence a user has that the requested (and now, displayed) page will lead to the given data topic. The second feedback input is received in block 106. An exemplary embodiment of a display requesting a feedback input from a user is illustrated in FIG. 3.

FIG. 3 includes an example of a web browser page, however other embodiments may use other interfaces to conduct the search for information. In the illustrated example of FIG. 3, the user has been asked to find information on “Great Danes.” A first page 301 is shown. The first page 301 has a unique identifier 303. The unique identifier 303 is a uniform recourse locator (URL), but may be any other type of unique identifier. Since the user is looking for data on “Great Danes,” the user has selected a first link 304 “Dogs” from the first page 301. The selection of the first link 304 is a request for another page linked to the first link 304. Once the user has selected “Dogs” a feedback meter 305 is displayed over the first page 301. The feedback meter in the illustrated example asks the user to “Rate how confident you are that you are getting closer to your goal?” and provides buttons 107 that the user may choose to input a first feedback input. The illustrated embodiment uses buttons 107, and asks for a confidence ratting, however other embodiments may ask other similar questions and use other types of feedback inputs such as, for example a sliding scale, a number input, or the feedback meter 305 may have an entry field for text comments that may be entered by the user. Once the user has entered a first feedback input, the first feedback input is received as illustrated in block 103 (of FIG. 1).

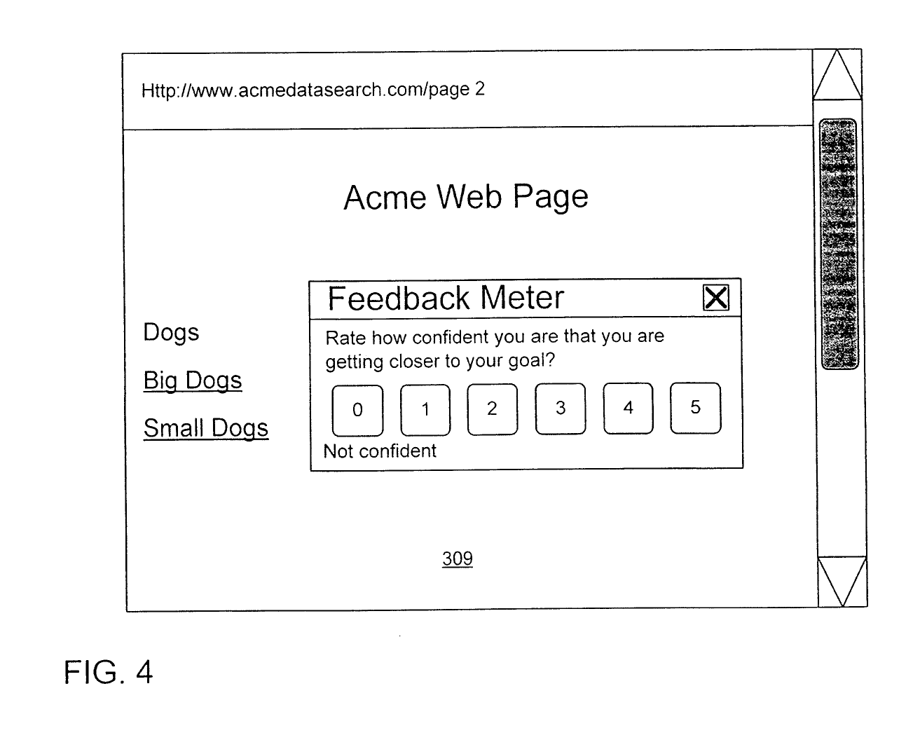

Once the first feedback input is received, a second page 309 (FIG. 4) is displayed. In the illustrated embodiment, the second page 309 is linked to the first link 304. Once the second page 309 is displayed, the user is requested to input a second feedback request in block 105. The second feedback input is received in block 106. Blocks 101 to 113 may be repeated for the a third page (not shown). A similar process for additional pages may continue until the user finds the data on “Great Danes.”

The first and second feedback inputs are associated with the unique identifier 303 of the first page 301. The amount of time the user spends looking at (accessing) the first page 301 may be determined in block 109. In block 111, the amount of time the user access the first page 301 is associated with the first and second feedback inputs. In block 113 the first and second feedback inputs, the unique identifier 303 of the first page 301, and the amount of time the user accesses the first page 301 is stored.

In block 115 (of FIG. 1), the stored feedback input, the identifier of the first page 301 and the amount of time the user accesses the first page 301 are compiled. The compiled information in block 115 may include any number of pages depending on how many pages the user accesses and whether the pages are designated by the tester to display the feedback meter 305. In block 117, the compiled information of block 115 is output to a display.

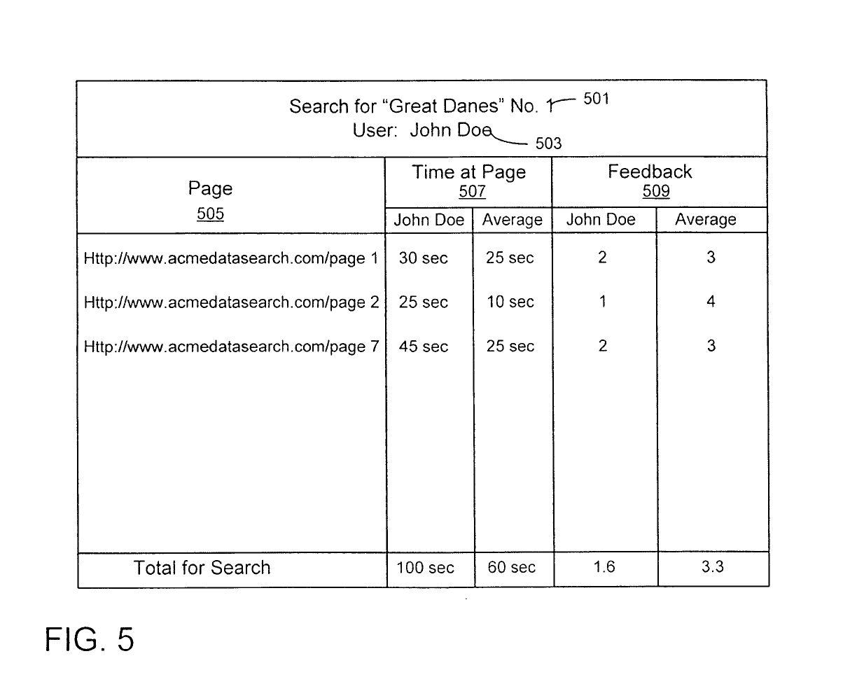

FIG. 5 illustrates an exemplary embodiment of an output from block 117. In this regard, a title of the search 501 “Great Danes No. 1” is displayed A user name 503 that identifies the user as “John Doe” is also displayed. The URLs of the pages searched are displayed in column 505. The time the user spent accessing the page is displayed in column 507, and a feedback input is shown in column 509. The average times spent accessing the pages and average feedback inputs from other users may also be displayed. Totals for the search are displayed at the bottom of FIG. 5. A similar display may also include, for example, data compiled from a number of users for particular pages.

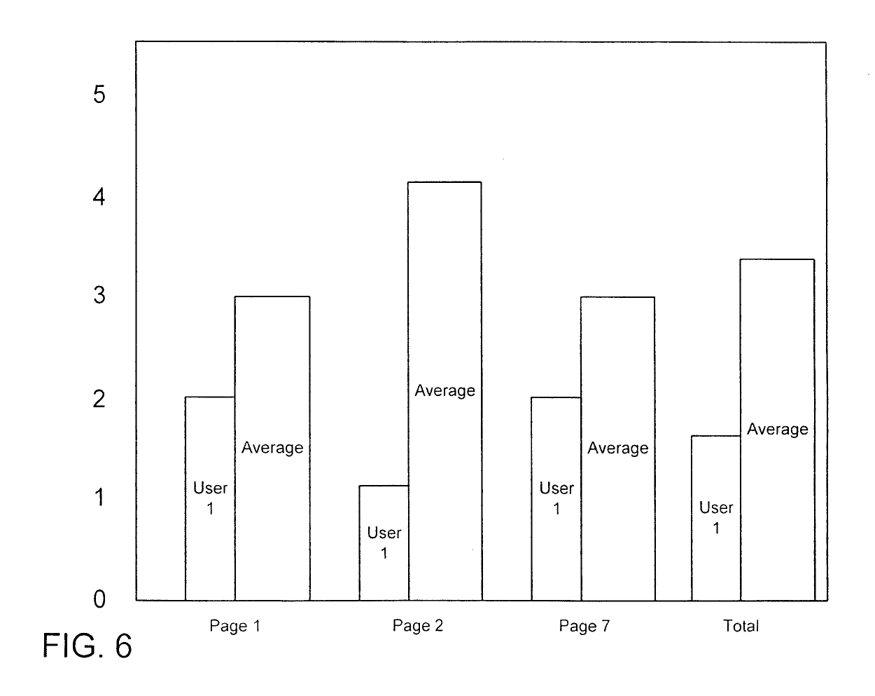

FIG. 6 illustrates an alternate embodiment of a display of compiled data from block 117. FIG. 6 shows a graph of feedback inputs for a user 1 and an average of the feedback inputs from a plurality of users. The display of the compiled data is not limited to the embodiments illustrated in FIGS. 5 and 6 and may include a number of other methods for displaying compiled data including, for example, charts and line graphs. Additionally, the compiled data may be processed to, for example, determine averages of times spent by one or a plurality of users on a particular page, a total time spent by users searching for particular data, median feedback input scores, and a combination of searches for other data topics by a particular user or a plurality of users.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for measuring user feedback during information retrieval testing, the method comprising:
determining whether a user has requested a page having a unique identifier in a data structure;
requesting a first feedback input from the user responsive to determining that the user has requested the page, wherein the first feedback input is associated with a search for data in the data structure;
receiving the first feedback input from the user;
displaying the page;
requesting a second feedback input from the user responsive to displaying the page, wherein the second feedback input is associated with a search for data in the data structure;
associating the first and second feedback inputs with the page; and
storing the first and second feedback inputs and a unique identifier of the page.

2. The method of claim 1, the method further comprising:
determining an amount of time a user accesses the page;
associating the amount of time a user accesses the page with the first and second feedback inputs; and
storing the amount of time a user accesses the page with the associated first and second feedback inputs.

3. The method of claim 1, the method further comprising:
compiling the stored first and second feedback inputs and an identifier of the page; and
displaying the compiled first and second feedback inputs and an identifier of the page.
